(19) United States
(12) Patent Application Publication
(10) Pub. No.: US 2009/0300030 A1
(43) Pub. Date: Dec. 3, 2009

(54) LARGE CAPACITY DATA PROCESSING MODELS

(75) Inventors: Lewis Charles Levin, Seattle, WA (US); Gurdeep Singh Pall, Medina, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/129,742

(22) Filed: May 30, 2008

(51) Int. Cl. G06F 17/30

(52) U.S. Cl. 707/100; 707/E17.005

(57) ABSTRACT

Data is processed with respect to large or practically infinite storage capacity. A cumulative data model is employed to organize accumulation of considerable amounts of data as well as facilitate interaction with the data. Accumulated data can be further processed to aid efficient location of relevant information. For instance, correlation and versioning operations, among others, can be performed to identify relationships amongst data and initiate removal of outdated data, respectively.

### BACKGROUND

The ubiquity of computers and like devices has resulted in digital data proliferation. Technology advancements and cost reductions over time have enabled computers to become commonplace in business and at home. By way of example, individuals interact with a plurality of computing devices daily including work computers, home computers, laptops, and mobile devices such as phones, personal digital assistants, media players, and/or hybrids thereof. Consequently, an enormous quantity of digital data is generated each day including messages, documents, pictures, music, video, etc. Such data is often accumulated over time for later retrieval, analysis, mining, or other use. Generally, data falls into one of two categories: structured or unstructured.

Structured data is data structured or organized in a specific manner to facilitate identification and retrieval of data, for instance in response to a query. Computer databases are the most common example of structured data since they house data as structured collections of records. In particular, a schema provides a structural description of the types of data and relationships amongst data held in a database. Further, schemas are organized or modeled as a function of a particular database model.

The most popular database model today is the relational database model. This model specifies that information be organized in terms of one or more tables including a number of rows and columns where relationships are represented utilizing values common to more than one table. In this case, the schema can act to identify specific table, row, and column names.

Unstructured data is the opposite of structured data. More specifically, it does not include any defined or standard structure to aid processing. There are two primary classes of unstructured data, namely bitmap and textual. Bitmap data is non-language based spatially arranged bits. Examples of bitmap data include images, audio, and video. Textual data is language based and includes email, word processing documents, web pages, and reports, among others.

It is to be noted that data conventionally classified as unstructured may not be completely devoid of structure. For example, a word processing document will include a plurality of words that together satisfy a grammar of the written language. As another example, a web page can include a high degree of structure directed toward formatting. However, there is no structure to facilitate more complex contextual computer processing. Sometimes this class of data is referred to as semi-structured to clarify that the data does in fact include some structure.

Indexing is often employed to expedite location of structured and unstructured data. For example, traditional databases and search engines utilize an index. An index is queried and employed to locate relevant information, rather than performing a brute force search or scan over a collection of data requiring considerable time and computational power. Expeditious query processing speed on the front-end is enabled by substantial back-end index generation work. In general, such work entails analyzing all data in a corpus and extracting index terms. Subsequently, re-indexing is performed to account for new, removed, and/or updated data.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to data processing in light of large or practically infinite storage capacity. In accordance with one aspect, a cumulative data model is provisioned to facilitate processing of considerable quantities of data, where conventional models, including those that utilize indexes, break down. More specifically, the cumulative data model is designed to support large-scale accumulation of data as well as efficient management and interaction.

According to one embodiment, a data processing system is provided that accumulates blocks of data (e.g., structured, unstructured, semi-structured . . . ). A management component organizes the data in accordance with a cumulative data model. The data and organizational structure are saved to a data store such as volatile computer memory or nonvolatile storage. Subsequently or concurrently, additional processing including correlation and versioning can be performed, among other things. The system also includes functionality to support efficient querying of the data utilizing the underlying organizational structure.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a data processing system in accordance with an aspect of the subject disclosure.

FIG. 2 is a block diagram of a representative management component according to a disclosed aspect.

FIG. 3 is a block diagram of a representative data modeling component in accordance with an aspect of the disclosure.

FIG. 4 is a block diagram of a representative data store depicting graphically an exemplary data organization in accordance with a disclosed aspect.

FIG. 5 is a block diagram of a representative request processor component according to an aspect of the disclosure.

FIG. 6 is a flow chart diagram of a data organization method according to an aspect of the disclosure.

FIG. 7 is a flow chart diagram of a method for interacting with data in accordance with an aspect of the disclosed subject matter.

FIG. 8 is a flow chart diagram of a method of processing data requests in accordance with a disclosed aspect.

FIG. 9 is a flow chart diagram of a method of processing data according to an aspect of the disclosure.

FIG. 10 is a flow chart diagram of a method of correlating data in accordance with a disclosed aspect.

FIG. 11 is a flow chart diagram of a method of versioning according to an aspect of the disclosure.

FIG. 12 is a schematic block diagram illustrating a suitable operating environment for aspects of the subject disclosure.

FIG. 13 is a schematic block diagram of a sample-computing environment.

### DETAILED DESCRIPTION

Systems and methods are described in detail hereinafter pertaining to data processing in view of large or practically infinite storage capacity. Cumulative data models designed to cope with massive quantities of data can be employed to aid processing. In one instance, attributes are created for data blocks or objects upon accumulation in a volatile or non-volatile store. In addition to defining access to data blocks, attribute data can be employed for correlation, versioning, and pre-fetching operations, among other things.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

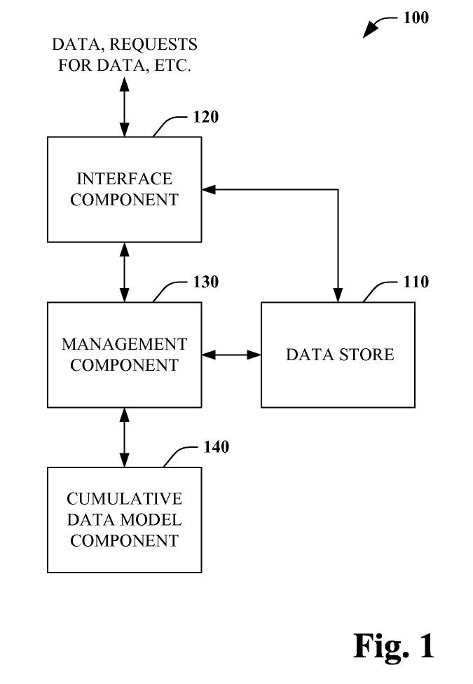

Referring initially to FIG. 1, a data processing system 100 is illustrated in accordance with an aspect of the claimed subject matter. Current and foreseeable technological advancements and cost reductions continue to impact storage capacity in significant ways. More specifically, capacity continues to double on average every two years in accordance with Moore's Law. The system 100 is directed toward processing such substantial amounts of data, although it has applicability to smaller data sets as well. The system 100 includes a data store 110, interface component 120, management component 130, and cumulative data model component 140.

The data store 110 houses a set of data for a period of time to facilitate processing thereof. Accordingly, the data store 110 can correspond to either a volatile or non-volatile storage mechanism such as computer's memory (e.g., Random Access Memory (RAM)) or hard drive (e.g., disk storage, flash . . . ), among others. Moreover, the data store 110 can be high capacity. In one case, capacity can refer to the amount of data able to be stored relevant to another store or other stores. Additionally or alternatively, capacity can refer to the ability to store all needed or desired data at once. In this instance, a high capacity store can be practically infinite. For example, a computer's memory can be so large it can hold all cached program data without swapping data in and out of memory. Similarly, due to the extensibility of databases and associated components, individuals need not be concerned with storing too much information.

The interface component 120 receives, retrieves, or otherwise acquires data and/or requests for data for the system 100. Such data can be structured, unstructured, and/or semi-structured. Upon acquisition of data, the interface component 120 can transmit (or otherwise make accessible) such data to the data store 110 and/or the management component 130. For example, in one embodiment, the interface component 120 can provide such data to the data store 110 and notify the management component of its arrival and location.

The management component 130 manages all data housed by the data store 110. More particularly, the management component 130 can organize or otherwise process such data to facilitate efficient response to queries. This can include but is not limited to contextualizing data, identifying relationships between data, and/or determining when new data should replace old data to improve processing. It is to be noted that management functionality provided by component 130 can be performed in the background as part of a background service and/or dynamically upon receipt of data or a request for data.

In one instance, the management component 130 can employ the cumulative data model component 140 to organize data. As the name suggests, the cumulative data model component 140 is designed to deal with cumulative data or accumulation of data of various types and amounts to facilitate retrieval or other interaction. Accordingly, the model and/or associated schema(s) can be designed to be extensible or support addition of various kinds of data easily. Further, the model can be designated in a manner that is conducive to interaction with large or unlimited amounts of data where conventional models and techniques fail. For example, conventional calculated indexes cannot be employed because the cost of index generation and regeneration is prohibitive for large data sets.

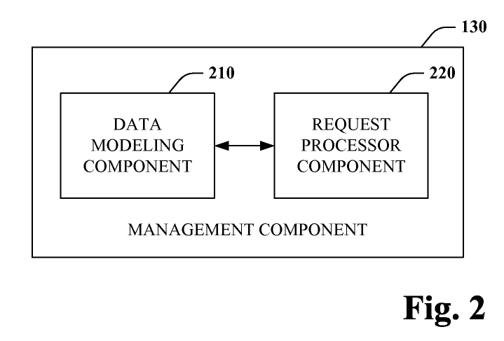

FIG. 2 depicts a representative management component 130 according to an aspect of the claimed subject matter. As shown, the management component 130 includes a data modeling component 210 and a request processor component 220. The data modeling component 210 generates a cumulative data model, associated schema, and/or instance thereof. For example, as data blocks or objects are received or retrieved they can be analyzed, organized, and/or processed in accordance with the model. In one embodiment, the organization can ensure that data is modeled only once to support accumulation and processing of large amounts of data. The request processor component 220 processes requests for, or queries of, data. Since, processing can be dependent upon the data model employed, the request processor component 220 can be communicatively coupled to the data modeling component 210 and/or the actual model generated.

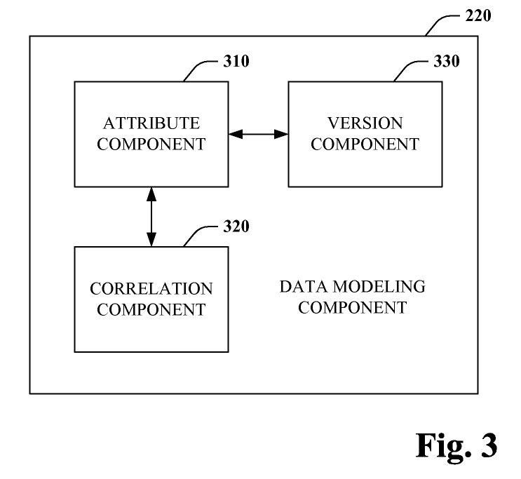

A representative data modeling component 210 is illustrated in FIG. 3 according to one aspect of the subject claims. The component 210 includes an attribute component 310 that generates attributes in accordance with a model, related schema(s) or meta schema(s) for acquired data. Such attributes can be fairly rich to differentiate practically infinite quantities of data including but not limited to a name, data properties, and a pointer to the location of associated data. In an electronic communication domain, for example, attributes can include but are not limited to the type of communication (e.g., Instant Message (IM), email, Voice over Internet Protocol (VoIP) . . . ), sender identity, recipient identity, and the path utilized to establish communication (e.g., phone number).

Once attributes are set they need not be reset. By contrast, consider a classic database type schema with calculated indexes to locate data. Here, the schema is not cumulative and index generation is prohibitive for large data sets. Further, when new data is added that is substantially different from old data in classic database systems, re-indexing is performed. However, the single most expensive operation that can be performed on large data sets is one that analyzes each piece of data as is done with conventional indexing. Moreover, the cost increases as data is accumulated, which is antithetical to a cumulative scheme.

While one characteristic of attributes is that they can be generated as a function of a given model or schema, they can also impact the same model or schema in a cumulative manner. More specifically, the attribute component 310 can recognize new attributes, attribute values, and/or tags gradually, for example. By way of example, consider a communication object including a set of attributes such as type of communication, sender identity, and recipient identity. If some objects also include the time of day the communication is sent, this can be identified as a new property for utilization. Similarly, durable inbound and outbound IP address could be added. Thus, the attributes, properties or the like can also be cumulative in nature.

Generated attributes or data block identifiers can be employed in further processing operations. In particular, the correlation component 320 can utilize data attributes to determine, infer, or otherwise identify relationships amongst data. By way of example, where an identifier associated with a voice call is the same as an identifier for an email correspondence, the correlation component 320 can identify the relationship between the voice call and email data and construct a connection. These connections can also be constructed where values are associated with different attribute tags. For instance, the identifier can be associated with a caller in one case and a sender in another. Similarly, if an individual drew a picture the attribute could be “drawer” or “author,” among other things. By correlating attributes or portions thereof, related data can be retrieved quickly.

Correlation can be performed at different times. Accordingly, correlation can form part of a background process and/or a runtime or dynamic process, among other things. Once relations are identified, connections can be built in various ways between dissimilar items with different arrival times.

In addition to correlation, versioning can be performed by the version component 330. Since data is being accumulated, multiple entries can exist for the same data, for instance where the data is updated or altered. The version component 330 can identify numerous versions of the same data as part of a background process or dynamically.

In simple scenario, the version component 330 can simply identify substantially the same attribute or set of attributes. Upon detection, the version component 330 can delete or initiate deletion of the older versions (e.g., make available for garbage collection). It is to be noted that the decision to delete versions need not be directed toward memory preservation since a large store is presumed. Rather, the version component 330 can determine whether or not an old version should be deleted as a function of the ability to manage, locate, and/or search data. Hence, if can be established that the presence of stale data does not negatively effect the ability to manage, locate, and/or search data within a threshold, it need not be removed. Conversely, if removal of such data will improve such processing of data substantially or within a threshold, deletion can be initiated. In either case, the decision is based on factors other than memory preservation.

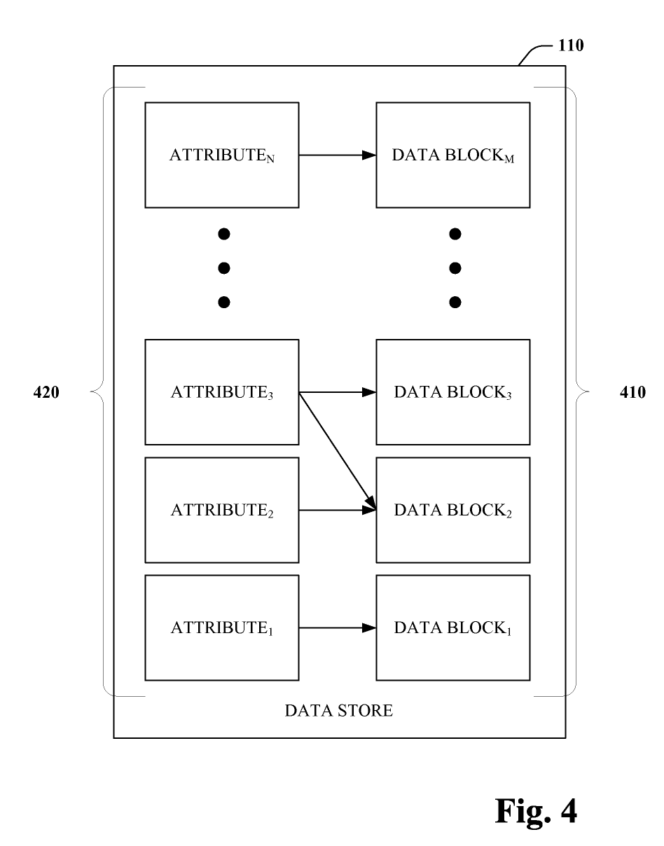

Turning attention to FIG. 4, a representative data store 110 is depicted in accordance with an aspect of the claimed subject matter. Within the data store 110 is a graphical depiction of one sample organization of data in accordance with a cumulative data model. As shown, the data store 110 includes a plurality of data blocks or objects 410 (DATA BLOCK₁-DATA BLOCK_{M}, where M is an integer greater than or equal to one). The data blocks 410 are organized as a stack or heap where new blocks are added to the top such that DATA BLOCK₁ arrived earlier than DATA BLOCK₂, for example. For each data block 110 there exists a corresponding or associated attribute, attribute data or set of attributes 420 (ATTRIBUTE₁-ATTRIBUTE_{N}, where N is an integer greater than or equal to one). Similar to the data blocks 410, attributes 420 can be organized as a stack or a heap. Further and as described supra, the attributes 420 can include relevant information organized in accordance with a particular schema. One portion of information can include a pointer to the related data block 410 represented as a horizontal arrow from an attribute 420 to a data block 410. Furthermore, data can relate to other data in many ways, for example, one data block 410 can be an update of another data block 410. This is represented graphically as another arrow as shown from ATTRIBUTE₃ to ATTRIBUTE₂. Links can be present, additionally or alternatively, amongst attributes themselves or represented by another structure (e.g. tree, graph . . . ).

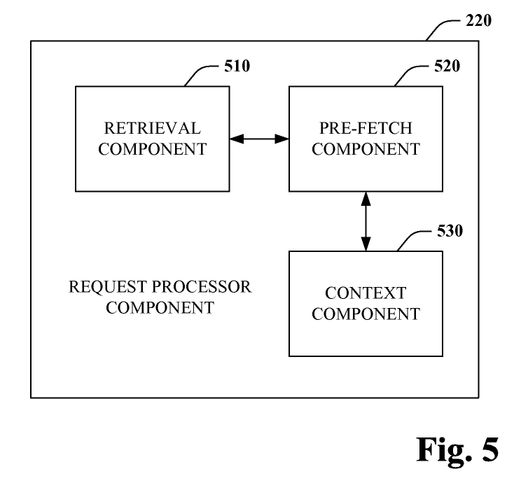

FIG. 5 depicts a representative request processor component 220 in accordance with a claimed aspect of the subject matter. The request processor component 220 facilitates provisioning of data in response to requests. In furtherance thereof, a retrieval component 510 is provided to process requests and return results. This can be accomplished by processing queries against an instance of the cumulative data model previously described. For example, a request can be processed against attribute data and pointers followed to return data associated with attributes satisfying the request.

The request processor component 220 can also include a pre-fetch component 520 communicatively coupled to the retrieval component 510 and context component 530. The pre-fetch component 220 is a mechanism to facilitate loading of memory with relevant information likely to be needed in the near future. The determination of what is relevant and likely to be needed can be based on a request itself, resultant data provided by the retrieval component 510, and/or other contextual information acquired and supplied by the context component 530.

The context component 530 can receive, retrieve, or otherwise acquire contextual information from within or outside a given system. For example, the context component 530 can acquire and provide information about an executing application or process. Based thereon, the pre-fetch component 520 can determine or otherwise infer data likely to be needed. It should further be appreciated that information regarding identification of pre-fetched data can be provided or otherwise made accessible to the data modeling component 210 (FIG. 2) to facilitate data organization and potentially reduce duplicative work.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. For instance, the request processor component 220 of FIG. 2 could be implemented as a separate component rather than a subcomponent of the management component 130. Further yet, one or more components and/or sub-components may be combined into a single component to provide aggregate functionality. For example, the interface component 120 of FIG. 1 could be embodied as a subcomponent of the management component 130. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the management component 130 can employ such mechanisms to facilitate construction of a cumulative data model. For instance, inferences can be made about data content to enable correlation of data including dissimilar attributes.

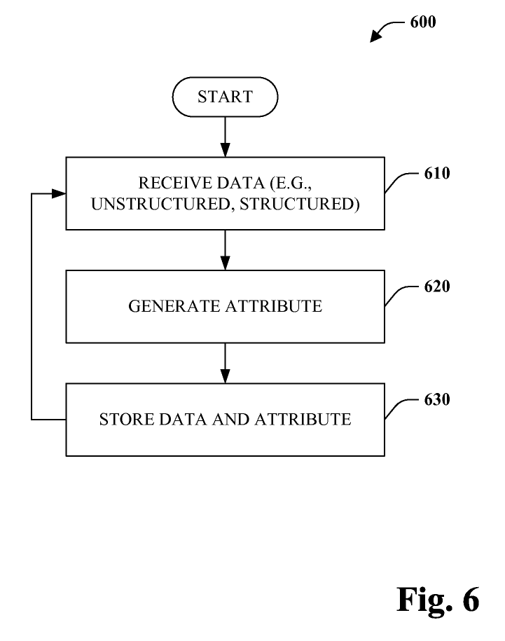

In view of the exemplary systems described supra, methodologies that may be implemented in accordance with the disclosed subject matter will be better appreciated with reference to the flow charts of FIGS. 6-11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 6, a method of organizing data 600 is depicted in accordance with an aspect of the claimed subject matter. At reference numeral 610, data is received, retrieved, or otherwise acquired. Such data can be of various different types or categories including structured, unstructured, and/or semi-structured data. At numeral 620, an attribute, set of attributes or attribute data is generated for the acquired block of data. Generation of the attribute can be governed by a model or schema, for instance for a particular domain or context such as electronic communications. An exemplary attribute can include information about the type of communication, the sender, and the receiver. Additionally, the attribute can include a pointer to the location where the data is to be stored. At reference 630, the attribute and data are stored. Storage can comprise loading the attribute and data to volatile computer memory or persisting the same to a non-volatile store, among other things. Subsequently, the method can proceed back to 610 where it awaits receipt of the next piece of data and the method continues to loop and accumulate data as expected.

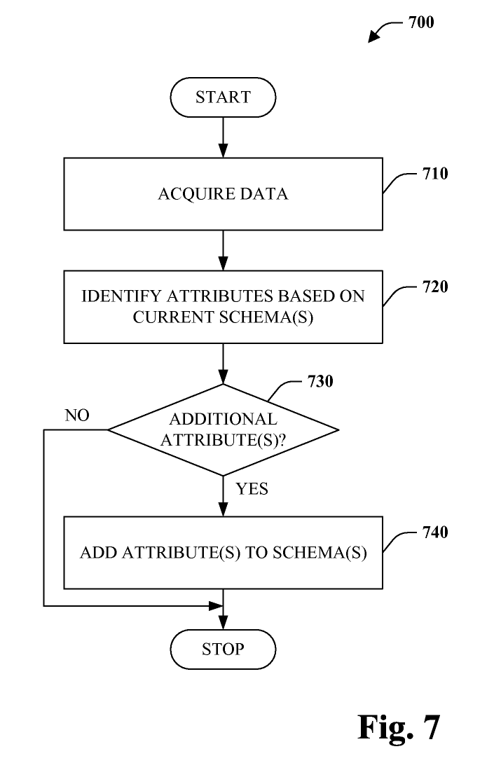

FIG. 7 is a flow chart diagram illustrating a method of data processing 700 in accordance with an aspect of the claimed subject matter. The method 700 provides acts associated with interacting with data stored in a cumulative manner. At reference numeral 710, it is determined that one or more data blocks are needed. One or more attributes are identified associated with needed data at 720. At reference 730, a request is made for data utilizing the identified attribute(s). Finally, data is received in response to the request at reference numeral 740.

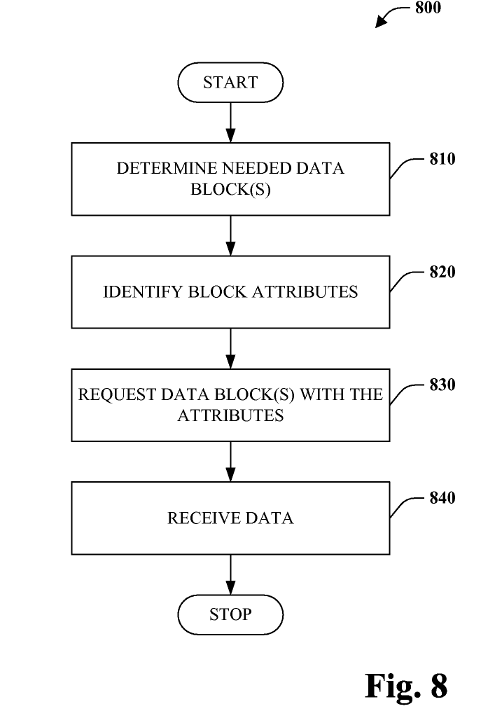

Turning attention to FIG. 8, a method of processing data requests 800 is depicted in accordance with an aspect of the claimed subject matter. At reference numeral 810, a query or request for data is received. At numeral 820, attributes, attribute data, or sets of attributes are identified that are relevant to the request. The attributes are generated upon receipt of data, and they include pertinent information regarding the data in a particular form. Accordingly, location of data relevant to the request can involve querying the attributes or alternatively a structure that returns attributes. Utilizing the identified attribute or attributes, associated data is located at reference 830. For example, this can correspond to locating a pointer to the data provided by the attribute. At reference numeral 840, the located data is returned in response to the request and the method 800 terminates.

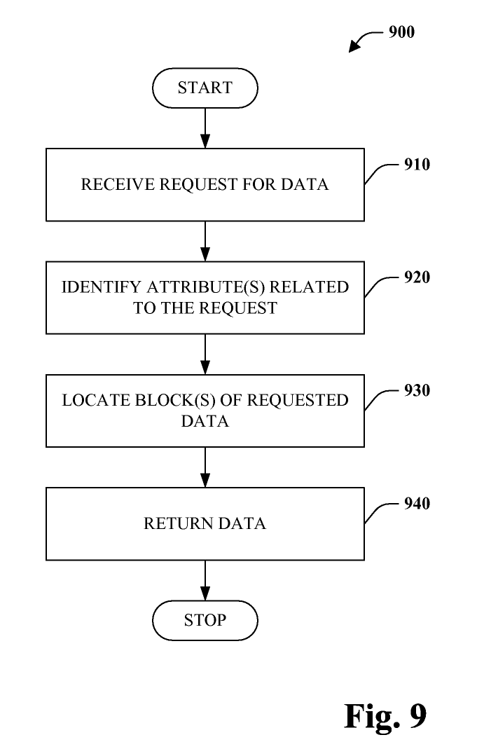

FIG. 9 depicts a method of processing data 900 to facilitate interaction with accumulated data. At reference numeral 910, a block of data is received, retrieved, or otherwise acquired. The data can be of any form including but not limited to structured, unstructured, or semi-structured. Utilizing a current general or domain specific schema, an attribute or set of attributes are identified at numeral 920, which can be employed to generate an attribute as a function of the data. At numeral 930, the block of data is further analyzed to determine if the content lends itself to an additional attribute(s) for organizing the data. If no, the method 900 simply terminates. If yes, the addition attribute(s) are added to the schema at reference numeral 940. For example, where an electronic communication schema includes attributes associated with a sender and a receiver, analysis of the data could result in identification of a date the communication was sent and received. As a result, a date attribute can be added to the schema such that subsequent processing will look for and record such information where available. Hence, the data schema is designed to be cumulative or additive similar to the cumulative nature of the data itself as described herein.

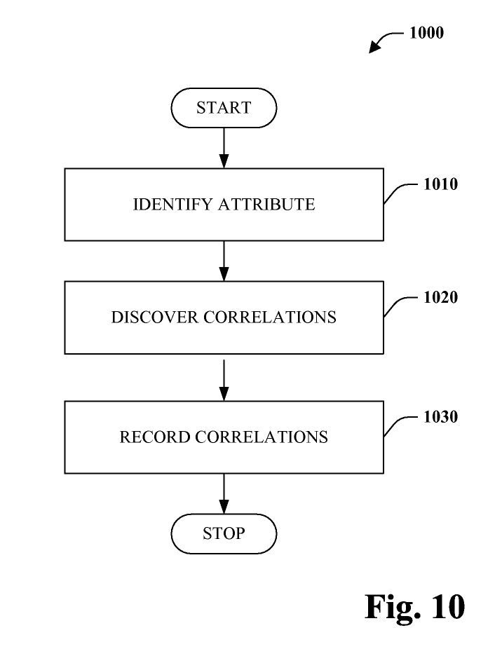

FIG. 10 is a flow chart diagram illustrating a method 1000 of correlating data in accordance with an aspect of the claimed subject matter. At reference numeral 1010, an attribute or portion thereof is identified. For example, the identified attribute can be “author” of value “John.” At reference numeral 1020, correlations are discovered with respect to the identified attribute. In a simple scenario, other attributes that include “author” of value “John” can be located. More complex discovery methods can also be employed utilizing coded knowledge and/or machine learning, for instance. Continuing with the example, it may be known, learned, or inferred that “author” is often equivalent to “writer.” Accordingly, any attribute including “writer” of value “John” can also be identified as related. At reference numeral 1030, discovered correlations are recorded for subsequent use in retrieving relevant or related data. In one embodiment, the recordation can be within the attributes themselves and/or in a separate structure defining relations such as a tree or graph.

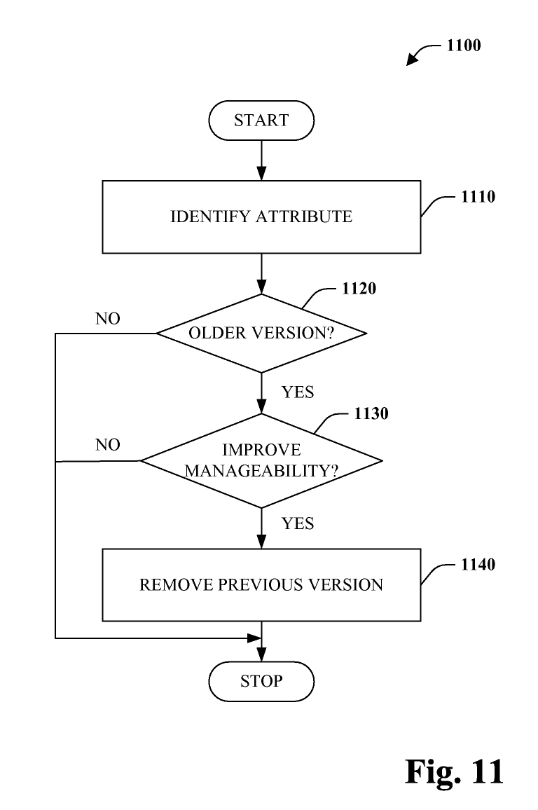

Referring to FIG. 11, a flow chart diagram depicts a versioning method 1100 according to an aspect of the claimed subject matter. At reference numeral 1110, attribute data related to a data block is identified. A determination is made, at reference numeral 1120, as to whether the data block is an old version. In other words, the determination is whether a subsequent data block exists that updates the data block. If the data block not an old version, the method 1100 simply terminates. Alternatively, if the block is an old version, the method continues at reference 1130 where a determination is made as to whether removal or the data will improve management, location, and/or search of the set of data blocks. If no, the method 1100 terminates. However, if yes, the method proceeds to reference numeral 1140 where the older or previous version is removed. Note that conventionally older versions of data are almost always removed where storage space is an issue. On the other hand, if storage space is not a concern, there is no need to remove older versions of data unless there is some benefit in doing so.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

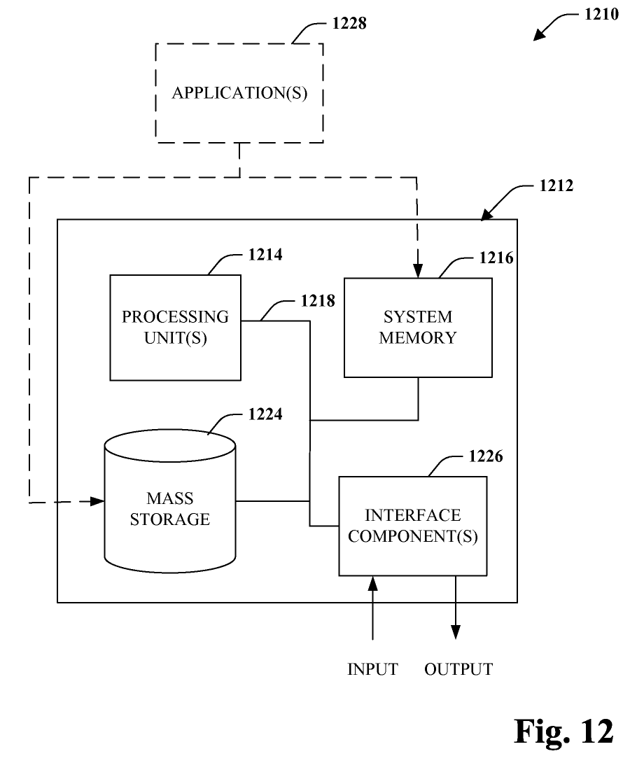

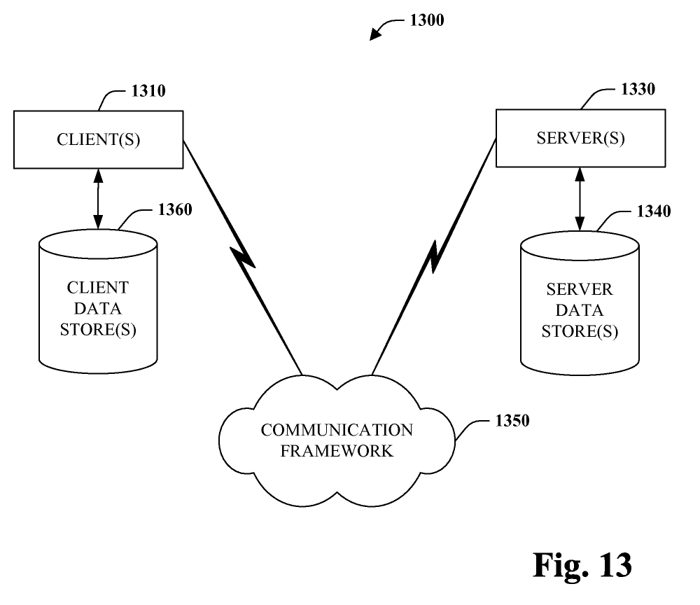

In order to provide a context for the various aspects of the disclosed subject matter, FIGS. 12 and 13 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 12, an exemplary environment 1210 for implementing various aspects disclosed herein includes a computer 1212 (e.g., desktop, laptop, server, hand held, programmable consumer or industrial electronics . . . ). The computer 1212 includes a processing unit 1214, a system memory 1216, and a system bus 1218. The system bus 1218 couples system components including, but not limited to, the system memory 1216 to the processing unit 1214. The processing unit 1214 can be any of various available microprocessors. It is to be appreciated that dual microprocessors, multi-core and other multiprocessor architectures can be employed as the processing unit 1214.

The system memory 1216 includes volatile and nonvolatile memory. The basic input/output system (BIOS), containing the basic routines to transfer information between elements within the computer 1212, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1212 also includes removable/non-removable, volatile/non-volatile computer storage media. FIG. 12 illustrates, for example, mass storage 1224. Mass storage 1224 includes, but is not limited to, devices like a magnetic or optical disk drive, floppy disk drive, flash memory, or memory stick. In addition, mass storage 1224 can include storage media separately or in combination with other storage media.

FIG. 12 provides software application(s) 1228 that act as an intermediary between users and/or other computers and the basic computer resources described in suitable operating environment 1210. Such software application(s) 1228 include one or both of system and application software. System software can include an operating system, which can be stored on mass storage 1224, that acts to control and allocate resources of the computer system 1212. Application software takes advantage of the management of resources by system software through program modules and data stored on either or both of system memory 1216 and mass storage 1224.

The computer 1212 also includes one or more interface components 1226 that are communicatively coupled to the bus 1218 and facilitate interaction with the computer 1212. By way of example, the interface component 1226 can be a port (e.g., serial, parallel, PCMCIA, USB, FireWire . . . ) or an interface card (e.g., sound, video, network . . . ) or the like. The interface component 1226 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer, and the like. Output can also be supplied by the computer 1212 to output device(s) via interface component 1226. Output devices can include displays (e.g. CRT, LCD, plasma . . . ), speakers, printers, and other computers, among other things.

FIG. 13 is a schematic block diagram of a sample-computing environment 1300 with which the subject innovation can interact. The system 1300 includes one or more client(s) 1310. The client(s) 1310 can be hardware and/or software (e.g., threads, processes, computing devices). The system 1300 also includes one or more server(s) 1330. Thus, system 1300 can correspond to a two-tier client server model or a multi-tier model (e.g., client, middle tier server, data server), amongst other models. The server(s) 1330 can also be hardware and/or software (e.g., threads, processes, computing devices). The servers 1330 can house threads to perform transformations by employing the aspects of the subject innovation, for example. One possible communication between a client 1310 and a server 1330 may be in the form of a data packet transmitted between two or more computer processes.

The system 1300 includes a communication framework 1350 that can be employed to facilitate communications between the client(s) 1310 and the server(s) 1330. The client(s) 1310 are operatively connected to one or more client data store(s) 1360 that can be employed to store information local to the client(s) 1310. Similarly, the server(s) 1330 are operatively connected to one or more server data store(s) 1340 that can be employed to store information local to the servers 1330.

Client/server interactions can be utilized with respect to various aspects of the claimed subject matter. By way of example and not limitation, blocks of data can be resident on one or more server data store(s) 1340 and transmitted from a server 1330 to a client 1310 utilizing the communication framework 1350. Additionally, requests for data can be initiated by a remote client 1310 and directed across the framework 1350 to a server 1330 that accumulates data in one or more data stores 1340 in accordance with the cumulative data model described supra. Further yet, data storage and/or processing can be distributed across one or more clients 1310 and/or servers 1330.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A data processing system, comprising:
an interface component that acquires blocks of data; and
a management component that organizes the data in accordance with a cumulative data model to support accumulation of large amounts of data.

2. The system of claim 1, the interface component acquires blocks of structured and/or unstructured data.

3. The system of claim 1, further comprising a large capacity store that stores the data and an organizational structure.

4. The system of claim 3, the store is computer memory.

5. The system of claim 3, further comprising a component that returns requested data from the store in response to a request.

6. The system of claim 1, the management component generates attributes identifying relevant information pertaining to related data blocks including location.

7. The system of claim 6, further comprising a component that correlates data as a function of attributes and/or values of attributes.

8. The system of claim 6, further comprising a version component that identifies different versions of the same data based on the attributes and initiates removal of instances of data that have been updated to aid retrieval of other data.

9. The system of claim 1, data is organized in a non-indexed heap.

10. The system of claim 9, the organizational data is located in a separate heap.

11. A method of data processing, comprising:
accumulating a large quantity of data blocks for storage; and
labeling each block of data once upon receipt with a set of attributes identifying the block and properties thereof to facilitate subsequent retrieval without an index.

12. The method of claim 11, further comprising identifying relationships between data blocks.

13. The method of claim 12, further comprising dynamically correlating data upon receipt.

14. The method of claim 12, further comprising inferring related data where attribute values are dissimilar.

15. The method of claim 11, further comprising analyzing an acquired block of data and labeling the block in accordance with a domain schema.

16. The method of claim 15, further comprising identifying a new attribute associated with the data and adding the attribute to the domain schema.

17. The method of claim 11, further comprising identifying an update version of a data block upon receipt, and deleting a previous version to further facilitate subsequent retrieval.

18. A data processing system, comprising:
means for acquiring blocks of unstructured data; and
means for generating attributes identifying relevant information about the blocks in accordance with a cumulative data model schema.

19. The system of claim 18, further comprising a means for correlating the data utilizing the attributes.

20. The system of claim 18, further comprising a means for housing the data in a non-indexed heap.
